(19) United States
(12) Patent Application Publication
(10) Pub. No.: US 2026/0118533 A1
(43) Pub. Date: Apr. 30, 2026

(54) TECHNIQUE FOR DETERMINING THE SMEARING OF THE KINETIC ENERGY OF A HADRON BEAM

(71) Applicant: INSTYTUT FIZYKI JADROWEJ IM. HENRYKA NIEWODNICZANSKIEGO POLSKIEJ AKADEMII NAUK, Krakow (PL)

(72) Inventors: Wiktor PAROL, Krakow (PL); Pawel KULESSA, Wegrzce (PL); Adam KOZELA, Krakow (PL)

(21) Appl. No.: 19/158,428

(22) PCT Filed: Feb. 23, 2024
(86) PCT No.: PCT/PL2024/000008

§ 371 Date: Aug. 20, 2025

(30) Foreign Application Priority Data
Feb. 28, 2023 (PL) P.443932

(51) Int. Cl. G01T 1/29

(52) U.S. Cl. CPC G01T 1/29

(57) ABSTRACT

A technique for determining the smearing of the kinetic energy of a hadron beam, using elements of the particle time of flight method, where all amplitudes for the measured signals S^{A}(k) and S^{B}(k) are recorded simultaneously from two detectors (A) and (B) located at a precisely defined distance L from each other and connected to the processing unit enabling the analysis of images recorded by both detectors, placed along the line of the studied hadron beam, over a period of time corresponding at least to 100 times the theoretical value for the time of flight of a hadron beam particle between the detectors (A) and (B), with time resolution at least on the level of 0.5 ns. Signals, for which the amplitude value is lower than the defined noise level and signals, the profile of which deviates from the determined reference profile, are eliminated.

The subject of the invention is a method for determination of the smearing of the kinetic energy of a hadron beam, wherein the energy is defined with high precision, thus enabling effective use of such a beam in experimental physics, for therapeutic purpose, as well as in some highly specialised industrial technologies which require a well-defined energy beam in the range over 500 keV. The information regarding the distribution of the beam energy around the mean energy value is extremely important from the point of view of interpretation of scientific experiments.

Devices of various design, the so-called accelerators, are used to generate ionising radiation beams, wherein they accelerate charged particles, imparting them with high energy. The particles are accelerated using electric field and the acceleration method involves acting on the particle beam e.g. with constant voltage, with high frequency, induced or multi-stage, while magnetic field is used to direct the accelerated particles along the respective path or focus the particles. Magnetic field is generated using electromagnet blocks located along the accelerator line/circuit.

A number of particle acceleration methods is known, e.g. electrostatic acceleration, using standing or travelling wave (resonance cavity), as well as in plasma. Each of the methods requires complicated accelerating structures involving i.e. electromagnets operating at very high frequencies, on the order of several GHz. Magnets focusing and correcting the beam path and its diagnostics elements are installed between the accelerating structures. Each interaction of the hadron beam with the generated electromagnetic fields results in an energy change of the hadron beam. Parameter change (instability) of the devices accelerating and shaping the beam, as well as collisions between the particles or passing through a degrader (obstacle) in any form results in unspecified influence on the energy of the hadron beam. The use of hadron beams in experimental physics, for therapeutic purposes, as well as in some highly specialised industrial technologies requires the kinetic energy of the used beams to be extremely precisely defined or measured. It is possible to calculate the kinetic energy of the hadron beam used theoretically, on the basis of the parameters of the accelerator used, but sometimes this yields a coarse approximation with inadequate accuracy. It is then necessary to determine or measure the actual value of kinetic energy of the beam before it is used for experimental, therapeutic or industrial purposes.

The information regarding smearing of the kinetic energy of the hadron beam is extremely important during all scientific experiments and proton therapies, namely information about the distribution of beam energy around the mean value which should be applied or observed. For example, smearing of spectral lines located close to each other may prevent them from being distinguished. In the case of a proton beam used during the experiment, it is expected that it shall have strictly defined energy required to study the given reaction. Beam smearing causes reactions close to the required energy value also to occur, resulting in further smearing of the measured values.

Beam energy is the average value of energy of particles comprising the beam. Beam smearing is a distribution of energy values for individual particles around the mean value. The less smeared the beam is, the more precisely defined its energy and thus, better control over the experiment or therapy. Beam smearing means that individual protons hitting the target at an energy different from the preset value become dispersed. The smearing of hadron beams has not been previously studied because of the problematic implementation of measurements for individual particles. A number of solutions was identified during an analysis of the state of the art in the field of hadron beam energy measurement, which were used with full particle packets, namely always measured the average particle energy.

The analysis of the state of the art also indicates that intensive search for solutions aimed at a method of effective and precise measurement or determination of the kinetic energy of a hadron beam intended for use in applications which require accurate, precise and reliable data on the kinetic energy of the used beam result in a number of protected inventive solutions and scientific information disclosing the related solutions.

The patent document EP3155456 B1 discloses a system for measurements of a mono-energy hadron beam, characterised in that it includes the first detection unit including a planar sensor with a detection area, divided into a pixel matrix. Each pixel is adapted to provide a transit signal indicating particle flight and a counting system coupled with the sensor in order to provide output signal indicating the number of particles, e.g. of a beam passing through the aforementioned detection area over a time range, according to the transit signals provided by the aforementioned pixels and a second detection unit placed below the first detection unit and containing at least one ionisation detector to provide the output signal proportional to the total charge Qion released by the beam in the ionisation detector over the aforementioned time range. In the aforementioned solution, energy is measured on the basis of recording fo the number of particles in one detector and their total energy loss resulting from ionisation in the other detector. The time interval is a period of time, during which a measurement is carried out.

The invention disclosed in the patent document CN102488971 B is related to dynamic proton imaging in real time and a radiotherapy imaging method. According to this method, proton energy is received by a detector in the form of a thin-layer transistor made of amorphous silicon with a caesium iodide film and subjected to a digital-analogue conversion in order to create an image. This method is characterised in that the proton energy is obtained twice, once before proton emission to the detected object and again, after proton passage through the examined object. The data obtained from double acquisition is processed in order to generate an image.

The publication by Z. Kormány, titled.: “A new method and apparatus for measuring the mean energy of cyclotron beams”, Nuclear Instruments and Methods m Physics Research A 337 (1994) 258-264, discloses a method of measurement of the average energy of a beam obtained from the CV28 cyclotron at KFA Jülich. This method uses two capacitive transducers installed along a straight line, such that the lower transducer may be moved along the beam axis. The measurement is carried out fully on-line and a personal computer controls the position of the probe and evaluates the signal generated by the HF detector electronics. The solution disclosed in this work is based on the TOF (Time of Flight) measurement method. This method applies only to a cyclotron beam divided into packets. This method measures the time of flight for complete packets, and the average beam energy is obtained as the result.

The patent document U.S. Pat. No. 10,792,517 B2 discloses a method and a device used to determine the status of a positively charged particle, such as a proton, for use in imaging of a patient tumour before and/or simultaneously with a cancer therapy. The imaging system includes a transport path for positively charged particles, sequentially passing through the patient, the first time of flight detector and, having flown over a distance of the path, at least to the second time of flight detector using time between the detection of the time of flight and the path length in the first and the second detector in order to determine the energy loss of the particle, which is compared with the known energy of the incipient beam and used to generate a tumour image.

The international patent application WO2019197593 A1 discloses a time of flight (TOF) system used to measure the pulse energy of a hadron beam, wherein each pulse of the beam is ordered as a series of packets of charged particles, wherein these packets are repeated with a frequency in the range of radio frequency. The system includes the first detector, the second detector and the third detector located along the beam path, wherein each of the detector is configured to determine the passage of a charged particle packet and to provide the output signal which depends on the phase of the detected packet. The second detector is located at the first distance from the first detector, while the third detector is located at the second distance from the second detector. The first distance is determined such that the time of flight of the beam from the first detector to the second detector is approximately equal to or shorter than the packet repeating period, and wherein the second distance is determined such that the time of flight of the beam from the second detector to the third detector is greater than a multiple of the beam repeating period, and a processing unit configured to calculate the phase shifts between the detector output signals and to calculate the pulse energy on the basis of the calculated phase shifts.

The publication by Wei Liu et al., titled: “A beam energy time-flying measurement system”, Cyclotrons and Their Applications 2007, Eighteenth International Conference, presented a beam energy measurement system using time of flight measurements for a packet of a beam with periodic structure separated from the SFC (Sector Focusing Cyclotron). This system operates on-line and the accuracy of the beam energy measurement exceeds 5‰.

The patent publication U.S. Pat. No. 4,229,704 A discloses a charged particle beam packet, which is controlled with a signal generated in response to beam passage and added to the reference signal with a phase shift. The sum of both signals is amplified, detected and used in a synchronous detector in order to obtain a comparison between the phase of the reference signal and of the signal reacting to the beam packet. This comparison is the error signal used to control the beam, including beam packet cycling.

The publication by M. Kisieliński, J. Wojtkowska, titled: “The proton beam energy measurement by a time-of-flight method”, NUKLEONIKA 2007; 52(1):3-5 discloses a simple TOF apparatus used to measure the energy of cyclotron protons. For the short distance of 165 cm between the capacitive probes, the accuracy of energy measurement for a proton beam is on the level of 1% for average packet currents higher than 200 nA and within the energy range of 20-30 MeV. The solution disclosed in this work is based on the time of flight (TOF) method. This method applies only to a cyclotron beam divided into packets. This method measures the time of flight for complete packets, and the average beam energy is obtained as the result.

The methods used to determine the hadron beam energy known from the state of the art are complicated, time-consuming and with measurement accuracy on the level of approximately 1% of the average beam energy and do not allow for a measurement of its smearing, i.e. the distribution of particle energy around the mean energy value to be determined. A significant limitation of the known method for measurements of hadron beam energy also lies in the fact that the methods apply to measurements of beams generated in a cyclotron, transported in packets, and fail in the case of continuous beams. As a consequence, it is no longer possible to measure the energy of a beam with very low intensity, when signals induced by individual packets fall below the detection threshold or if the acceleration technique does not generate such packets (continuous beam).

The technical problem challenged by the invention involves the development of a method for fast determination of the energy smearing of a hadron beam with high accuracy, below 1%, which does not use complicated procedures and complicated apparatus and which enables efficient and repeated determination of the energy smearing of the hadron beam and of the kinetic energy of the hadron beam, both for beams generated as packets and for beams generated continuously in order to monitor and correct the beam parameters.

The essence of the method of determination of kinetic energy smearing of a hadron beam according to the invention, using elements of the particle time of flight method, executed in a system including a particle detector unit and a calculation unit enabling the analysis of images recorded by particle detectors, equipped with an oscilloscope card with the minimum bandwidth of 200 MHz and with the minimum sampling frequency of 4 GS/s is characterised in that a simultaneous, continuous recording of signal amplitudes, S^{A} and S^{B}, obtained from the particle detector unit is started, wherein the particle detectors are located along the light of the examined hadron beam, the first detector (A) and the second detector (B), with identical parameters and specifications, located at a precisely defined distance L from each other and independently connected to the calculating unit and forming a previously calibrated system for recording of the values if individual signal amplitudes S^{A} and S^{B}, which takes place with a time resolution of at least 0.5 ns. The system is calibrated using two different calibration procedure: one is used to calibrate time, the other—to calibrate smearing.

The amplitudes of unit signals S^{A}(k) and S^{B}(k) from both detectors (A) and (B), recorded simultaneously for protons of the measured hadron beam, are saved in the calculation unit for a period of time corresponding to at least 100 times the theoretical time of flight of a single particle of the hadron beam between the detectors (A) and (B). S^{A} and S^{B} denote ordered sets of signals recorded during the period of measurement carried out by the detectors A and B. Whereas, S^{A}(k) and S^{B}(k) denote individual sampled signal points (single sampling intervals—“bins”). Simultaneous recording of the amplitudes of measured signals S^{A} and S^{B} from both particle detectors (A) and (B) is archived in buffers of the calculating unit. Simultaneous recording of each pair of signals obtained from detectors A and B is indexed using the same variable determining the recording step k, obtaining signal profiles S^{A}(k) and S^{B}(k). An initial analysis of the S^{A}(k) and S^{B}(k) signals is carried out and they are considered equal to zero if the value of their amplitudes is lower than the specified noise level and these amplitude values S^{A}(k) and S^{B}(k) are eliminated. This is followed by the analysis of the shape of individual signals S^{A}(k) and S^{B}(k) most frequently recorded for the protons of the measured beam and the shape pattern is determined for these signals, then signals deviating from this pattern are removed. After the end of the recording period for the amplitude signals S^{A}(k) and S^{B}(k) from both particle detectors (A) and (B), an analysis of statistical correlation of signal profiles for S^{A}(k) and S^{B}(k), left at both detectors by multiple particles is carried out. The analysis includes a shift of the recorded signal profile from the particle detector (B) with its recording basis step k, compared to the determined signal profile from the particle detector (A), until a maximum overlap of the signal profiles is obtained for the signals S^{A}(k) and S^{B}(k). The maximum overlap of the analysed signals means that the minimum total difference between the profile amplitudes for signals S^{A}(k) and Sb(k)^{B}(k) has been achieved at the specific step k, corresponding to the time resolution with which the signals are recorded.

The number of steps k, determined during a measurement, from k=0 to k=N, is used to determine the multiplicity of steps k designated as τ^{D}, o by which the signal S^{B}(k) is shifted against the signal S^{A}(k), such that the following function reaches its minimum:

$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$

where: τ^{D} is a variable determining the shift between the compared signal, which achieves discrete values from the interval (0, N).

The position of the global minimum of the R(τ^{D}) function and the values of τ^{D}ₘᵢₙ, at which the R(τ^{D}) function reaches the global minimum are determined. Knowledge of the τ^{D}ₘᵢₙ value enables determination of the time corresponding to the time of flight of hadrons between the detectors (A) and (B), expressed by the formula t=Δt*τ^{D}ₘᵢₙ, where Δt is the length of a single sampling interval (0.5 ns).

Next, the precise average time of flight of the hadron beam is determined according to the relationship t=Δt*τₘᵢₙ, where Δt is the length of a single sampling interval, while τₘᵢₙ designates the real number τ, for which the ρ(τ^{D}) polynominal adapted to the R(τ^{D}) function reaches the minimum value. On the basis of the known time distance τ_{D}, for each individual pulse, in the S^{A} signal recorded at the first detector (A), its corresponding pulse is determined in the signal S^{B} recorded in the second detector (B), wherein both signals comprising the pair are located at the minimum time distance from each other. All pulses for which no pair has been found are zeroed and removed from the S^{A} or S^{B} signals. Next, the individual time distance is determined for each pulse pair and its distribution graph is generated. The Gaussian distribution function is fitted to the time distance distribution graph for all pairs found in the S^{A} and S^{B} signals. The average from the distribution corresponds to the average time of flight of the protons. The average kinetic energy of the beam is calculated from the time of flight read from the Gaussian distribution along the known path section L. From the Gaussian distribution, the standard deviation of the distribution comprising its dispersion is read and beam smearing is determined by taking into account the smearing calibration correction. The determined value of kinetic energy of the hadron beam is corrected with the known energy loss occurring during the passage through the first detector (A), by subtracting the literature value of energy losses in the used detector (A) and the smearing calibration correction is taken into account. The presentation of kinetic energy smearing for the hadron beam, corresponding to the standard deviation of the Gaussian distribution function, adapted to the distribution of individual time distances for all pulse pairs of the studied hadron beam and the presentation of the determined value of kinetic energy of the hadron beam mark the end of the procedure used to determine the smearing of kinetic energy of a hadron beam, and the detectors (A) and (B) are also removed from the travel path of the studied hadron beam.

Scintillation detectors placed along the line of the studied hadron beam are preferably used as particle detectors, such that the planes of the active part of the detectors are perpendicular to the direction of travel of the hadron beam.

The calibration measurement of the entire installation set up to execute the method of determination of kinetic energy of a hadron beam includes installation testing by carrying out individual measurements for detectors placed at a distance d=0, such that the active parts of both detectors are in contact and the system is considered calibrated when the determined, average time of flight for the hadrons reaches 0.

The calibration measurement for the time smearing measurement involves testing of the entire installation set up to execute the method of determination of kinetic energy of a hadron beam by carrying out individual measurements for detectors placed at a distance d=0, such that the active parts of both detectors are in contact and the dispersion of the time of flight of the hadrons determines the contribution of the used electronic systems to energy smearing.

The calibration measurement for the measurement of kinetic energy smearing of a hadron beam involves testing of the entire installation set up to execute the method of determination of kinetic energy of the hadron beam and to determine the smearing of kinetic energy of a hadron beam by carrying out the entire measurement procedure, followed by insertion of an active material onto the path of the hadron beam, upstream of the first detector, identical with the material used in the first detector and with the same thickness as the active material of the detector and repeating the entire measurement procedure. The difference in the smearing measurement is the calibration factor, i.e. it is the smearing generated during the measurement at the first detector.

In order to eliminate the signals S^{A}(k) and S^{B}(k), for which the amplitude values are below the specified noise level, said noise level is determined in algorithmic calculations on the basis of the statistical distribution of the sampled amplitudes and Gaussian function fitting around the maximum count, followed by determination of the zero level for the mean value of the distribution and the noise level is determined as at least 3σ, where σ is the standard deviation from the mean value of said distribution. The reference shape is also determined for individual signals most frequently recorded for the protons of the measured signal beam, used to remove the S^{A} and S^{B} signals, as well as the signals deviating from the determined reference shape, from the ordered signal set. The pulse length and its integrated surface area are accepted as the conformity criterion, followed by the rejection (amplitude zeroing) of pulses by deviating at least 3σ from the mean value for at least one parameter forming the criterion.

The method of determination of hadron beam kinetic energy smearing according to the invention is characterised by its high rate: the response follows measurement triggering almost immediately. The method of determination of hadron beam kinetic energy smearing uses the method of energy determination based on the overlapping of signals comprising individual pulses, thus enabling the use of single pulse pairs for measurements and enables the determination of the kinetic energy smearing of the hadron beam. The method uses the analysis of overlapping of signals containing multiple pulses of many particles, thus increasing the measurement reliability compared to known solutions based on the phase difference between two similar pulses. The reliable measurement obtained using the method according to the invention enables the determination of the value for energy smearing and the kinetic energy itself, just before the location where the beam is used.

Additional benefits offered include the ability to measure energy of continuous beams and very low intensity beans generated by cyclotrons, for which capacitive methods are ineffective.

The method of determination of hadron beam kinetic energy smearing is explained below using practical embodiments of the invention and the drawing, which shows, in

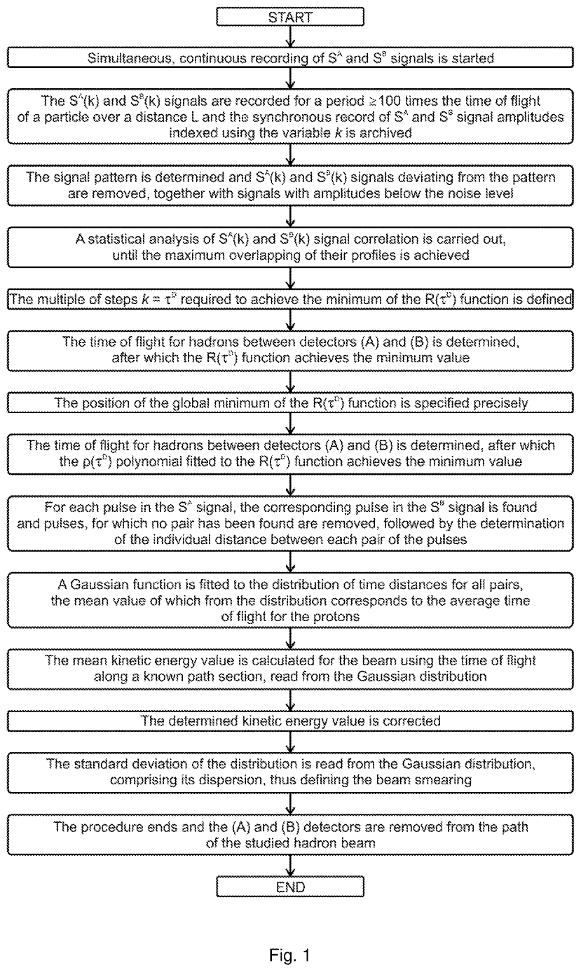

FIG. 1 the flow diagram for the algorithm according to the method, in

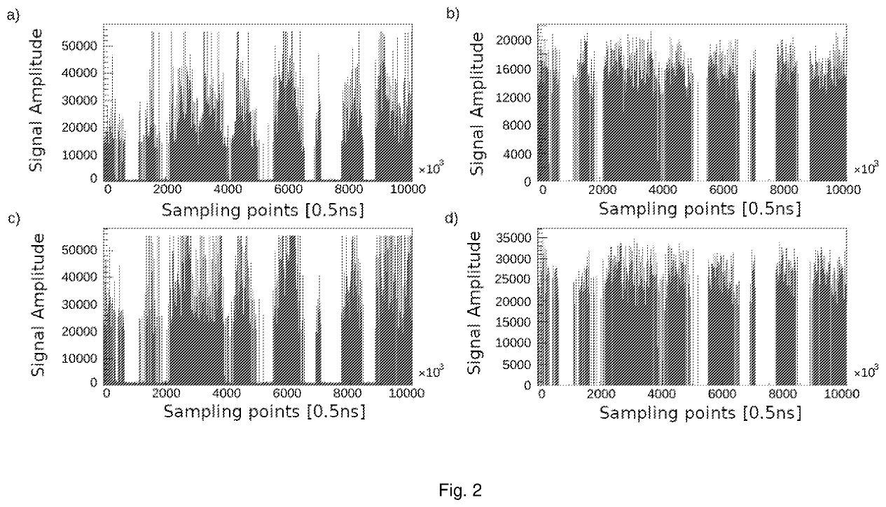

FIG. 2, signals from both detectors acquired during a single measurement lasting 5 ms, wherein the top row shows signals from detectors A and B after the initial processing and saving in the buffers, while the bottom row shows signals from detectors A nd B after the removal of signals from random particles from them on the basis of a shape analysis,

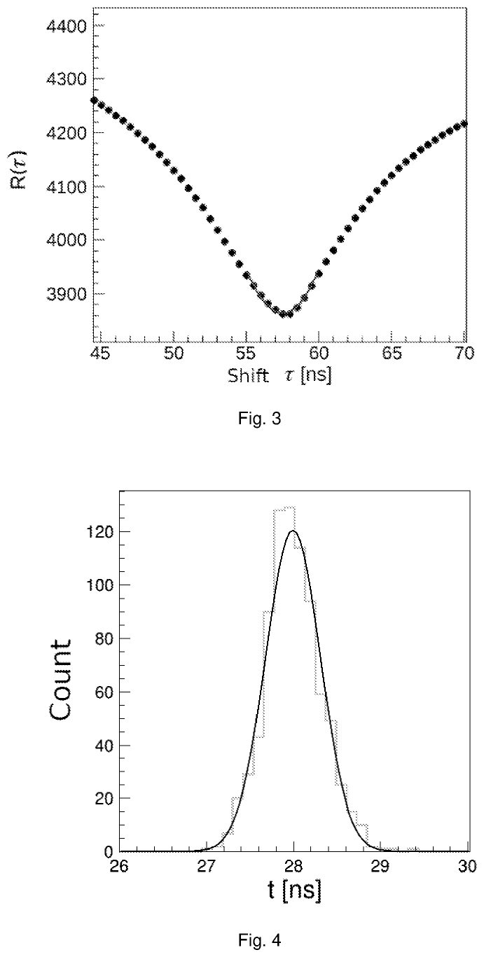

FIG. 3 shows the values of the signal overlapping function R (τ^{D}) [points], which depends on the signal shift step from detector B and the maximum signal overlapping occurs at the location of the R(τ^{D}) function minimum,

FIG. 4 shows the distribution of time of flight values for each pulse pair, namely for each proton individually, while

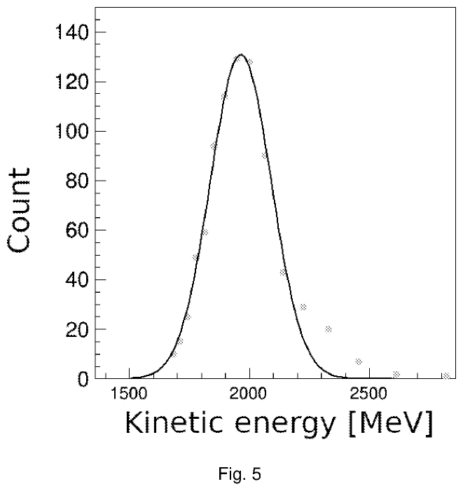

FIG. 5 shows the distribution of kinetic energy of individual protons corresponding to the distribution of their times of flight.

### EXAMPLE

An example execution of the method of determination of hadron beam kinetic energy smearing was carried out using a proton beam with the energy of 1.96 GeV and the current of several picometres, generated by the COSY cyclotron at Forschungszentrum Juliech. The installation for execution of the method was assembled using two particle detectors And B. Both detectors used square scintillation plastic panels BICRON, 90×90 mm and 5 mm thick as the active material. The light excited by the passing hadron beam particles was read on one side using four silicon photoamplifiers. The photoamplifier unit installed on the side of the active material panel was optically insulated against the ambient light. The electric signal acquired from photoamplifiers was sent through BNC cables to two channels of the oscilloscope card WaveSurfer 3024z installed in the central processing unit. The oscilloscope card channels were set to the single time interval of 5 ms recording, with a resolution of 0.5 ns per single bin (interval). The signal from each detector was saved in a separate memory buffer. Each buffer was designed to store at least 1×10⁷ points. The images saved in the buffers and generated in the detectors by the passing particles of the measured hadron beam were analysed using an algorithm executing the method of determination of kinetic energy of the hadron beam.

The distance between the detectors was set as d=7.93 m. A calibration measurement was carried out before the execution of the algorithm for determination of the kinetic energy of a hadron beam. The calibration measurement involved testing of the entire installation set up to execute the method of determination of kinetic energy of a hadron beam by carrying out individual measurements for detectors set at a distance d=0, which means that the active parts of both detectors were in contact. The calibration measurement was carried out in order to verify that the records of signals from both detectors do not show any delays related to incorrect design of the system.

The execution of the method of determination of kinetic energy of a hadron beam was preceded by the placement of detectors along the line of the examined hadron beam at a distance d=7.93 m, followed by the emission of a proton beam with the energy of 1.96 GeV.

The execution of the method of determination of kinetic energy of a hadron beam began with starting the synchronised, simultaneous and continuous recording of the values of individual signal amplitudes S^{A}(k) and S^{B}(k) from both particle detectors A i B, with a sampling rate of 500 ps over a signal interval of 5 ms. The recording of individual sampling points for both signals was carried out synchronously and indexed with the save variable determining the recording step k, as a result of signal recording throughout the entire measurement interval forming the profiles of signals S^{A}(k) and S^{B}(k). An initial analysis of the recorded signals was carried out and the zero level was determined for the signals, together with the noise level and the amplitudes of individual signals with a value lower than the threshold limit were removed (zeroed). At the same time, the initial analysis determined the characteristic pulse profile and the profile most frequently corresponding to the signals generated by protons with the energy of the studied beam, and signals deviating from the determined signal reference profile for a single particle were zeroed (removed) from the recorded signals S^{A}(k) and S^{B}(k). The output images of the signals S^{A}(k) and S^{B}(k) and the same signals after filtering carried out during the initial analysis are presented in FIG. 2.

After the initial analysis, a statistical analysis was carried out for the correlation of S^{A}(k) and Sb(k)B(k) signal profiles left in the detectors by many particles. It involved the shifting of the recorded S^{B}(k) signal profile recorded from the particle detector B, with its recording base step k, compared to the constant profile of the S^{A}(k) signal recorded from the particle detector A. After each operation for the specific k for the S^{B}(k), involving subtraction of the S^{B}(k) signal shifted by k+τ, where: τ means the time shift between the compared signals, the value of the total amplitude difference for signal profiles of S^{A}(k) and S^{B}(k) was determined for the specific step k, and the following function was created:

$$R ( {τ}^{D} ) = {\sum }_{k = 0}^{N} \vert {S}^{A} ( k ) - {S}^{B} ( k + τ ) \vert .$$

The number of steps k, executed during the measurement period and for the example execution of the method, was 1×10⁷ points. Next, the multiple of steps k designated with the symbol τ was determined, by which the S^{B}(k) signal was shifted compared to S^{A}(k), such that the maximum of the function R(τ). is achieved. The following value was achieved τ=57.

The global minimum of the R(τ) function was defined for the value τₘᵢₙ, which is the best fit for the time of flight of the hadrons between the detectors, expressed with the formula t=Δt*τₘᵢₙ, where Δt is the length of a single step. The value of t=28.5+/−0.5 ns was obtained.

The position of the global minimum of function R(τ) was determined on the basis of the fitted 5th order polynomial by using the least squares method for the distance |R(τ)−ρ(τ)|, where ρ is the fitted polynomial.

The aim of the performed statistical analysis for the correlation of signal profiles for S^{A}(k) and S^{B}(k) was to obtain the maximum overlap of the signal profiles for S^{A}(k) and S^{B}(k), which is equal to achieving the minimum total difference between the amplitudes of signal profiles for S^{A}(k) and S^{B}(k), at the specific step k. The graph of the R(τ) function for the executed example method of determination of hadron beam kinetic energy smearing is presented in FIG. 3.

Identification was carried out on the basis of the known time distance τ^{D}ₘᵢₙ, for each individual pulse, in the S^{A} signal recorded in the first detector A, and its corresponding pulse in the S^{B} signal recorded in the second detector B, wherein both signals comprising the pair are located at the minimum time distance from each other. All pulses for which no pair has been found were zeroed and removed from the S^{A} or S^{B} signals. Next, the individual time distance was determined for each pulse pair and its distribution graph was generated. The Gaussian distribution function was fitted to the time distance distribution graph for all pairs found in the S^{A} and S^{B} signals (FIG. 4). The average value for the distribution, corresponding to the average time of flight for the protons, was determined: t=27.99+/−0.01. The average kinetic energy of the beam was calculated from the time of flight read from the Gaussian distribution, along a known section of the path L. The distribution of kinetic energy for individual protons corresponding to the distribution of their times of flight was shown in FIG. 4. The standard deviation of the distribution, comprising its dispersion, was read from the Gaussian distribution, also comprising beam smearing equal to σ(E)=127.2+/−6.5. The determined value of kinetic energy of the hadron beam was corrected with the known energy loss occurring during the passage through the first detector A, by subtracting the literature value of energy losses in the used detector A and the smearing calibration corrections were taken into account. The presentation of kinetic energy smearing for the hadron beam, corresponding to the standard deviation of the Gaussian distribution function, adapted to the distribution of individual time distances for all pulse pairs of the studied hadron beam and the presentation of the determined value of kinetic energy of the hadron beam mark the end of the procedure used to determine the smearing of kinetic energy of a hadron beam, and the detectors A and B are also removed from the travel path of the studied hadron beam.

The determined value of kinetic energy of the hadron beam was corrected with the known energy loss occurring during the passage through the first detector (A), by adding the literature value of energy losses in the used detector, followed by removal of the scintillation detectors A and B from the movement path of the studied hadron beam.

As a result of the example procedure used to determine the kinetic energy smearing of the hadron beam according to the method of invention, the value of kinetic energy and beam smearing were determined. The obtained results differed by <than 1% from the smearing and kinetic energy values determined using other, more complex methods.

The use of the method of determination of hadron beam kinetic energy smearing and of hadron beam kinetic energy according to the invention enables the replacement or supplementation of difficult and complex methods previously used to determine the kinetic energy of hadron beams and surveillance expansion, and mainly, it allows the previously difficult to obtain information about the smearing of hadron beam energy during the use of hadron beams to be obtained, thus contributing to the improved reliability of effects achieved in scientific, therapeutic and technical applications.

1. Technique for determining the smearing of the kinetic energy of a hadron beam using elements of the particle time of flight method, executed in a particle detector unit system equipped with a processing unit enabling the analysis of images recorded by the particle detectors and including an oscilloscope card with a minimum bandwidth of 200 MHz and a sampling frequency of at least 4 GS/s, characterised in that
simultaneous, continuous recording of amplitude values for the S^{A} and S^{B} signals from the particle detector unit is started, with the detectors placed along the line of the studied hadron beam of the first (A) and the second (B) detector with identical parameters and specifications, placed at an exactly specified distance L from each other and connected independently with the processing unit and comprising a system previously calibrated for time and smearing measurements, recording the values of individual signal amplitudes for S^{A} and S^{B}, which is carried out with the time minimum resolution of 0.5 ns,
all amplitudes of the measured S^{A}(k) and S^{B}(k) signals from both detectors (A) and (B) are recorded, and the recording of individual sampling points for both signals is carried out synchronously and indexed using the same variable describing the recording step k, obtaining signal profiles S^{A}(k) and S^{B}(k), for a period of time corresponding at least to 100 times the theoretical value for time of flight of a single particle of the hadron beam between the detectors (A) and (B) and the simultaneous record of amplitudes is archived for the measured signals S^{A} and S^{B}
the amplitude value for signals S^{A}(k) and S^{B}(k) lower than the specified threshold value are considered to be zero and are eliminated,
an analysis of the profile of individual S^{A}(k) and S^{B}(k) signals most frequently recorded for protons of the measured beam is carried out and the reference profile is determined for these signals, followed by the removal of signals deviating from such a reference, and the S^{A}(k) and S^{B}(k) signals, the amplitude values of which are lower than the specified noise threshold, are also removed,
after the end of the recording period for amplitudes of signals S^{A}(k) and S^{B}(k) from both particle detectors (A) and (B), an analysis of the statistical correlation for the signal profiles for S^{A}(k) and S^{B}(k), left at both detectors by multiple particles, is carried out by shifting the recorded signal profile recorded from the particle detector (B) with its recording basis step k, compared to the constant signal profile from the particle detector (A), until the maximum overlap of signal profiles is achieved for S^{A}(k) and S^{B}(k), which is equivalent to achieving the minimum total difference between the amplitudes of signal profiles for S^{A}(k) and S^{B}(k), at the specified step k, corresponding to the time resolution used to record the signals,
the number of steps k, determined during a measurement, from k=0 to k=N, is used to determine the multiplicity of steps k designated as τ^{D}, by which the signal S^{B}(k) is shifted compared to the signal S^{A}(k), such that the following function reaches its minimum:
$$R ( {τ}^{D} ) = \frac{1}{N - {τ}^{D}} {\sum }_{k = 0}^{N - {τ}^{D}} \vert {S}^{A} ( k ) - {S}^{B} ( k + {τ}^{D} ) \vert$$
where: τ^{D} is a variable defining the shift between the compared signals and it assumes discreet values in the (0, N) range,
the location of the global minimum of the R(τ^{D}) function and the value τ^{D}ₘᵢₙ, corresponding to the time of flight of hadrons between the detectors (A) and (B) expressed using the formula t=Δt*τ^{D}ₘᵢₙ, where Δt is the length of a single sample interval (0.5 ns), are determined,
the average time of flight of a hadron beam is determined according to the relationship, t=Δt*τₘᵢₙ, where Δt is the length of a single sampling interval, while τₘᵢₙ designates the value, for which the polynomial ρ(τ^{D}) adapted to the R(τ^{D}) function reaches its minimum,
on the basis of the known time distance τ^{D}ₘᵢₙ, for each pulse in the S^{A} signal a corresponding pulse in the S^{B} signal is determined and all pulses without a pair are zeroed,
the individual time distance is determined for each pulse pair and its distribution graph is generated.
the Gaussian functions is fitted to the distribution of individual time lengths, the average of which from the distribution corresponds to the average time of flight of the protons.
the average kinetic energy of the beam is calculated from the time of flight along the known section of the path read from Gaussian distribution,
the standard deviation of the distribution comprising its dispersion is read from the Gaussian distribution and beam smearing is determined, taking into account the calibration correction for the smearing,
the determined value of kinetic energy of the hadron beam is corrected with the known energy loss occurring during the passage through the first detector (A), by subtracting the literature value of energy losses in the used detector (A) and the smearing calibration correction is taken into account,
the procedure determining the kinetic energy smearing for a hadron beam ends with determination of the standard deviation of the Gaussian distribution function, fitted to the distribution of individual time distances for all pulse pairs of the studied hadron beam and with determination of the value of kinetic energy of the hadron beam by specifying the determined energy value and removal of the particle detectors (A) and (B) from the travel path of the studied hadron beam.

2. A method according to claim 1, characterised in that scintillation detectors placed along the line of the studied hadron beam are used as particle detectors, such that the planes of the active part of the detectors are perpendicular to the direction of travel of the hadron beam.

3. A method according to claim 1, characterised in that the calibration measurement for the time measurement involves testing of the entire installation set up to execute the method of determination of kinetic energy of a hadron beam by carrying out individual measurements for detectors placed at a distance d=0 such that the active parts of both detectors are in contact and the system is considered as calibrated when the determined, average time of flight of the hadrons reaches 0.

4. A method according to claim 1, characterised in that the calibration measurement for the time smearing measurement involves testing of the entire installation set up to execute the method of determination of kinetic energy of a hadron beam by carrying out individual measurements for detectors placed at a distance d=0, such that the active parts of both detectors are in contact and the dispersion of the time of flight of the hadrons determines the contribution of the used electronic systems to energy smearing.

5. A method according to claim 1, characterised in that the calibration measurement for the measurement of kinetic energy smearing of a hadron beam involves testing of the entire installation set up to execute the method of determination of kinetic energy of the hadron beam and to determine the smearing of kinetic energy of a hadron beam by carrying out the entire measurement procedure, followed by insertion of an active material onto the path of the hadron beam, upstream of the first detector, identical with the material used in the first detector and with the same thickness as the active material of the detector and repeating the entire measurement procedure, while the difference in the smearing measurement is the calibration factor, i.e. it is the smearing generated during the measurement by the first detector.

6. A method according to claim 1, characterised in that the noise level is determined through algorithm calculations based on the statistical distribution of the sampled amplitudes and fitting the Gaussian function around the maximum count, followed by determination of the zero level for the average value of the distribution and of the noise as at least 30, where o designates the standard deviation from the mean value of this distribution.

7. A method according to claim 1, characterised in that a reference profile is determined for individual signals, most frequently recorded for protons of the measured signal beam, and the pulse length and its integrated surface area are accepted as the conformity criterion, followed by the rejection (amplitude zeroing) of pulses deviating by at least 30 from the mean value for at least one parameter comprising the criterion.
